(19) United States
(12) Patent Application Publication
(10) Pub. No.: US 2012/0117656 A1
(43) Pub. Date: May 10, 2012

(54) Security Validation of Business Processes

(75) Inventors: Wihem Arsac, Biot (FR); Luca Compagna, Mandelieu (FR)

(73) Assignee: SAP AG, Walldorf (DE)

(21) Appl. No.: 12/943,698

(22) Filed: Nov. 10, 2010

(51) Int. Cl. G06F 21/00

(52) U.S. Cl. 726/26

(57) ABSTRACT

Implementations of methods of the present disclosure include providing a process model based on the process, the process model comprising a plurality of tasks, receiving user input at a computing device, the user input specifying one or more security requirements, the user input relating each of the one or more security requirements to at least one task of the plurality of tasks, generating, using the computing device, a formal model of the process based on the process model and the one or more security requirements, the formal model being based on a specification meta-language, processing the formal model using a model checker that is executed on the computing device to determine whether violation of at least one of the one or more security requirements occurs in the process, generating an analysis result based on the processing, and displaying the analysis result on a display.

### BACKGROUND

Business processes can be a sequence of activities a business enterprise performs to produce a specific service or product for a customer. Business analysts can use business process modeling in order to generate a business process model that, when executed, produces the product or service for the customer. The business process model can include one or more related structured activities or tasks that, when performed, produce the desired resultant product or service for the customer. Many business organizations can use business process modeling in order to increase business flexibility and efficiency as one or more business process models may use the same business process.

### SUMMARY

When designing a business process, the security requirements related to the execution of a business process task are taken into consideration. The security requirements can include government mandated regulations and directives as well as mechanisms for fraud prevention. The business analyst, when using business process modeling to generate a business process model, can work with a security analyst regarding the security requirements. The business analyst can determine human task assignments based on the security requirements. The business process modeling system can attempt to enforce the assignments within the business process model. However, the business process modeling system may not guarantee the assignments fulfill the necessary security requirements for the business process. The dynamic and frequently changing environment in which the business process executes may delegate certain assigned tasks within the business process complicating the meeting of the security requirements by the business process.

A business analyst, when designing a business process model, can partially test and tune the business model to meet the security requirements. In contrast, automated reasoning techniques such as model checking can validate all the execution paths of the business process under design against the expected security requirements. Model checking can run an analysis (a security validation) on a formal model of the business process that includes the security requirements. The security validation of the business process can ensure the compliance of the business process with respect to the relevant security requirements. The results of the model checking can provide information regarding a breach in a security requirement (a security attack). The results can be provided to the business analyst in a format conducive to their understanding of the business process model. The business analyst can choose to correct the security breach by modifying the business process model. For example, the business analyst may choose to correct or modify the business process flow that caused the security attack by reassigning resources for one or more specific tasks in the business process. In another example, the business analyst may choose to correct the security breach by changing the confidentiality or privacy constraints with regard to particular data used in the business process. In some cases, the business analyst may not be able to make a correction to eliminate the possible security attack but will inform those concerned in the next stage of the business process of the situation for manual monitoring.

For example, a bank may provide loans to individuals with which they do business. The business process model for individual loan grants can include multiple tasks performed by one or more individuals within the bank. These individuals may be assigned to different working groups within the bank. For example, a pre-processing clerk may receive and identify the customer request for the loan, a post-processing clerk may determine if the customer qualifies for the loan, and a bank manager may provide the final approval for the loan. A business process model for individual loan grants can assign certain tasks to each of the example working groups within the bank who then delegate the task to one or more individuals within the working group. A business analyst creating the business process model may not be aware of the individuals within each working group. A model checker can check a formal model of the business process to determine if there are individuals within any of the working groups who may not access certain data related to the loan granting process (e.g., customer name, gender, ethnic background, etc.). In addition, the model checker can check the formal model of the business process to determine whether any individuals are prohibited from performing certain tasks within the loan grant process. For example, the individual who initiates the loan should be different from the individual who approves the loan to prevent a potential allegation of fraud.

The output of the model checker can present a potential security breach to the business analyst in a way that the analyst can understand. The analyst can then determine what changes, if any, to make to the business process model to correct for the attack. For example, the model checker identifies a security breach where the gender and ethnic background data for an individual loan applicant is presented to the bank manager who provides the final approval for the loan. In order to avoid any allegations of gender or race discrimination in the loan granting process, the model checker determines that this data need not be presented to the bank manager. The business analyst can redesign the business process model to hide the identified data from the bank manager when approving the loan.

Implementations of the present disclosure include computer-implemented methods of validating a process. In some implementations, a method includes providing a process model based on the process, the process model comprising a plurality of tasks, receiving user input at a computing device, the user input specifying one or more security requirements, the user input relating each of the one or more security requirements to at least one task of the plurality of tasks, generating, using the computing device, a formal model of the process based on the process model and the one or more security requirements, the formal model being based on a specification meta-language, processing the formal model using a model checker that is executed on the computing device to determine whether violation of at least one of the one or more security requirements occurs in the process, generating an analysis result based on the processing, and displaying the analysis result on a display.

In some implementations, a method further includes detecting an occurrence of a violation of at least one of the one or more security requirements based on the processing, and generating a violation found message and violation trace in response to detecting the occurrence of the violation, the analysis result being based on the violation found message and the violation trace.

In some implementations, a method further include generating an output of the model checker, the output comprising a violation trace, and translating the violation trace to provide one or more graphical objects, the analysis result comprising the graphical objects. The violation trace can include one or more string steps, each graphical object of the one or more graphical objects corresponding to a string step. Each string step of the one or more string steps can include an instantiated rewrite rule of the specification meta-language. In some implementations, translating the violation trace includes determining a violation type, parsing the violation trace, and generating one or more workflow steps based on the violation type, each of the one or more graphical objects corresponding to a workflow step. In some implementations, generating one or more workflow steps includes determining that a string step of the violation trace comprises a main string step type, extracting a workflow object, and creating a main work flow object step based on the workflow object. In some implementations, generating one or more workflow steps includes determining that a string step of the violation trace comprises a predefined string step type, extracting data from the string step based on the predefined string step type, generating a workflow object step based on the data, and appending the workflow object step to a main workflow object step.

In some implementations, the model checker evaluates a transition system in view of the one or more security requirements, the transition system including one or more states provided as a set of facts that satisfy a set of clauses, at least one of the one or more states including a violation state.

In some implementations, a method further includes determining that a violation of at least one of the one or more security requirements did not occur based on the processing, and generating a violation not found message, the analysis result being based on the violation not found message.

In some implementations, a method further includes receiving additional user input at the computing device, modifying the process model based on the additional user input to provide a modified process model, generating, using the computing device, a modified formal model of the process based on the modified process model and the one or more security requirements, the modified formal model being based on the specification meta-language, and processing the modified formal model using the model checker to determine whether violation of at least one of the one or more security requirements occurs in the process.

In some implementations, the one or more security requirements include one or more of a need-to-know security requirement, a confidentiality security requirement, a separation of duty security requirement, and a binding of duty security requirement. In some implementations, the confidentiality security requirement includes one of a forbidden user security requirement, a user role security requirement, and a forbidden organization security requirement.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is to say that methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system that can execute implementations of the present disclosure.

FIG. 2 is an example business process model using business process modeling notation (BPMN).

FIG. 3 is a flow diagram of a business process modeling (BPM) procedure that includes a security validation procedure in a BPM environment.

FIG. 4 is a flowchart depicting an example security validation process.

FIG. 5 is an example loan organization business process model using business process modeling notation (BPMN).

FIG. 6 illustrates an example model checker output raw attack trace where a need-to-know security attack is detected.

FIG. 7 illustrates a graphical view of an analysis result.

FIG. 8 is a flowchart of an example process for translating a raw output trace into an analysis result.

FIG. 9 is a flowchart of an example process for parsing a string step list to create workflow steps for an analysis result.

FIG. 10 is a schematic illustration of example computer systems that can be used to execute implementations of the present disclosure.

Like reference symbols in the various drawings indicate like elements.

### DETAILED DESCRIPTION

Implementations of the present disclosure are generally directed to systems and methods for automated validation of the security related aspects of a business process using model checking. Business analysts can use one or more user interfaces to set up and run a validation tool that checks all possible business process system behaviors to determine whether any behavior violates a defined security requirement. The user interface provides the business analyst with a set of security requirements for the business process that the analyst can evaluate. The business analyst can provide one or more parameters for each of the security requirements using the user interface. The business analyst starts the validation process by activating the validation tool using a control provided by the user interface. The user interface provides information related to the outcome of the validation process to the business analyst. In the case of a violation of a security policy, the validation tool determines the problem with respect to a security requirement. The validation tool provides the business analyst with a visual representation of the problem in the user interface in a format familiar to the business analyst. The business analyst can determine the source of the problem and determine how and whether to resolve the problem.

The validation tool can be integrated with industrial business process modeling systems. For example, the validation tool can be implemented as a plug-in program that can be integrated in a business process management system. The use of a validation tool enables model checking in the business process modeling system to validate all execution paths of the modeled business process design against expected security requirements. The use of model checking techniques to validate security requirements in business systems can include the generation of a formal model of the business process on which to run the validation process. In addition, the use of model checking techniques to validate security requirements in business systems can include presenting the results of the model checking to the business analyst in manner that the business analyst can easily recognize and understand. For example, a business analyst can be presented with a user interface accessible from within the business process modeling system that provides an interface to the business process model design in order to evaluate security requirements and set parameters for the security requirements. In addition, the user interface can provide the results of a validation process to the business analyst in such a way that the analyst can identify the security violation and determine the business process activities executed to produce the violation.

The use of an integrated validation tool in a business process design can improve the quality, robustness and reliability of the business process resulting in the design of a security-compliant business process. The security validation approach followed in the design of the business process can provide a business analyst with a user interface incorporating a push-button approach to determine and validate the security requirements for the business process model. The security requirements for the business process model can be data-related security requirements under dynamic resource allocation. For example, the validation tool can determine whether a design for a business process fulfills the desired security requirements related to data flow (e.g., need-to-know) under dynamic resource allocation.

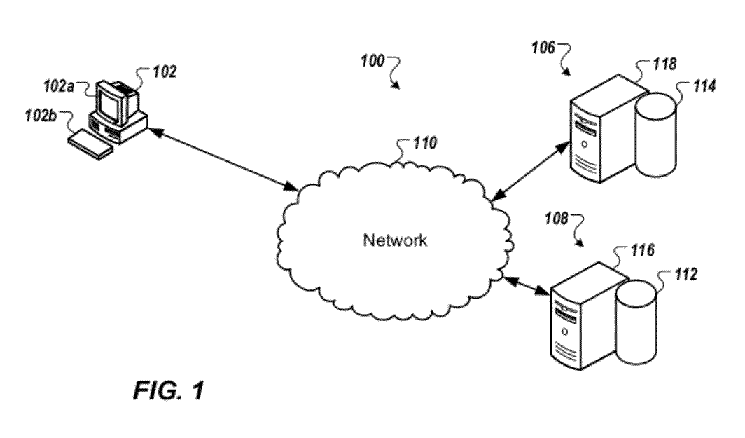

FIG. 1 depicts an example system 100 that can execute implementations of the present disclosure. The system 100 can include a client 102 and computer systems 106, 108. The computer systems 106, 108 can include servers 116, 118 and databases 112, 114, respectively. In some implementations, the system 100 may represent a client/server system supporting multiple computer systems (e.g., computer systems 106, 108) including one or more clients (e.g., client 102) and/or one or more servers (e.g., servers 116, 118) that are connectively coupled for communication with one another over a network 110. In some implementations, the clients (e.g., client 102) may be directly connected to the one or more servers (e.g., servers 116, 118) (without connecting by way of network 110).

The client 102 can represent various forms of processing devices including, but not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The client 102 may access application software on the servers 116, 118.

The servers 116, 118 can represent various forms of servers including, but not limited to a web server, an application server, a proxy server, a network server, or a server farm. For example, the server 116 can be an application server that executes software accessed by client 102. In operation, multiple clients (e.g., client 102) can communicate with the servers 116, 118 by way of network 110. In some implementations, a user can invoke applications available on the servers 116, 118 in a web browser running on a client (e.g., client 102). Each application can individually access data from one or more repository resources (e.g., databases 114, 116). For example, the servers 116, 118 can access databases 114, 116, respectively.

In some implementations, the client device 102 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some implementations, the system 100 can be a distributed client/server system that spans one or more networks such as network 110. The network 110 can be a large computer network, such as a local area network (LAN), wide area network (WAN), the Internet, a cellular network, or a combination thereof connecting any number of mobile clients, fixed clients, and servers. In some implementations, each client (e.g., client 102) can communicate with the servers 116, 118 via a virtual private network (VPN), Secure Shell (SSH) tunnel, or other secure network connection. In some implementations, the network 110 can include the Internet, a wireless service network and may include the Public Switched Telephone Network (PSTN). In other implementations, the network 110 may include a corporate network (e.g., an intranet) and one or more wireless access points.

The client (e.g., client 102) can establish its own session with the servers 116, 118. Each session can involve two-way information exchange between the computer systems 106, 108 and the client 102. For example, a Hypertext Transfer Protocol (HTTP) session can allow the association of information with individual users. A session can be stateful session, in which at least one of the communicating parts (e.g., the servers 116, 118 or the client (e.g., client 102)) stores information about the session history in order to be able to communicate. Alternatively, stateless communication during a stateless session includes independent requests with associated responses.

For example, referring to FIG. 1, the computer system 106 hosts a business process management system (BPMS) platform (e.g., SAP® NetWeaver™ Business Process Management system) on the server 118. The client 102 accesses the BPMS platform by connecting to the computer system 106 by way of the network 110. A business analyst, using the client 102, can model, manage, monitor, and analyze business processes using the BPMS platform. The business analyst can implement business process improvements and dynamic modifications as part of the design of the business process model. A security validation tool can be a plug-in program for a development platform (e.g., the Eclipse platform) that provides an integrated development environment (IDE) for tool integration for the BPMS platform.

The BPMS platform can provide a user interface to the business analyst on client 102 (e.g., a graphical user interface (GUI) displayed on display device 102a). The business analyst can interact with the user interface in the design of and subsequent analysis of a business process model. For example, the user interface presents security requirements and parameters for a business process in a format readily understood by the business analyst. The database 112 can store the security requirements and parameters used in the business process. The business analyst, interacting with the user interface (e.g., selecting entries using a touch screen of the display device 102a, entering data using a keyboard 102b), can identify security requirements and set one or more parameters for a security requirement. The business analyst can activate a user control to initiate the model checking of the business process model using the entered security parameters. The client 102 can display the results of the model checking on the display device 102a in a manner easily understood by the business analyst. If the model check identifies a violation of a security requirement, the user interface can present to the business analyst the related data flow and resource allocations that caused the security violation.

The business analyst can determine if and how to prevent the security violation, update and change the data-related security requirements for the business process model, and initiate a model check for the updated business process model. The updating of a business model and the subsequent model checking can be iteratively performed until no security violations are detected or until the business analyst determines that the identified one or more security violations can be managed in the next process step.

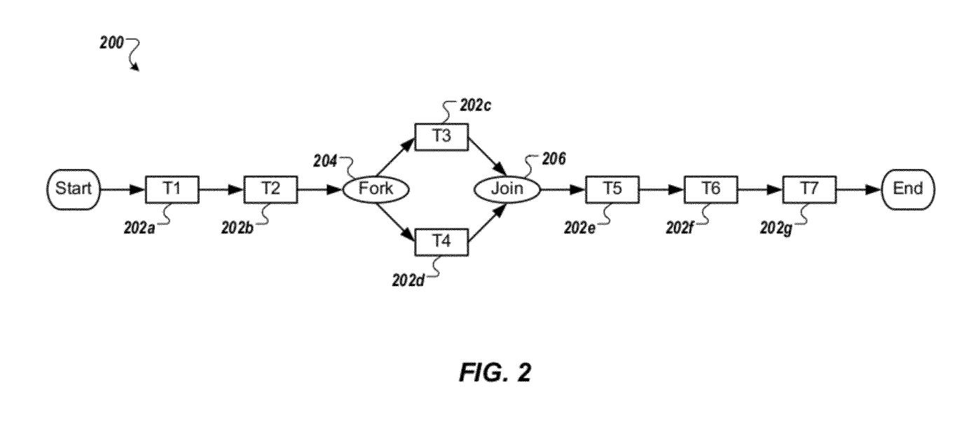

FIG. 2 is an example business process model 200 using business process modeling notation (BPMN) (BPMN model 200). A business analyst can design the sequence of tasks 202a-g executed by business resources to perform the business process. For example, the business analyst can use an interactive graphical user interface with BPMN to design the BPMN model 200. In some implementations, one or more identified BPMN pools can interact with the tasks 202a-g, where the responsibility for the execution of the tasks 202a-g is in one of the identified pools. A pool can include one or more business resources (e.g., users) that contribute to the execution of the tasks 202a-g. The pools can interact with one another using a message exchange system. A message received from another pool can start the business process by triggering the task 202a. A message sent to another pool from the pool executing the tasks 202a-g can request information needed for the execution of a specific task.

The BPMN model 200 shows the flow of tasks 202a-g performed by business resources to achieve the business goal of the business process model. In some implementations, the business resources can be grouped into one or more resource roles. For example, users can be placed into resource roles such as clerical roles or managerial roles. An identity management tool can implement role based access control (RBAC) with delegation for business resources. The RBAC can be connected to a business process in order to the manage access control for the business resources in the business process model.

A business analyst can perform dynamic resource allocation by assigning user roles to a task. The assignment of user roles can provide the user with the authorizations needed to fulfill specific tasks for a business process within an organization. The use of RBAC along with business process modeling enables the defining of roles, users, user-to-role assignments and delegation rules for the business process model. For example, when designing the BPMN model 200, the business analyst associates with each task 202a-g of the BPMN model 200 a set of potential owners and a set of excluded owners. The owner or principal can be a business resource (e.g., a user) or a resource role (e.g., clerical, managerial).

When executing the business process model, a specific user can claim a task ready for execution, if the owners of the task includes the user, or if the user is assigned to the resource role associated with the task. In addition, the user cannot be included among the excluded owners or resource roles associated with the task. Once the user claims the task, the user can execute the task. In some situations, if the user cannot execute the claimed task (e.g., they are called away unexpectedly), the user can delegate the task to a delegated user. The delegated user is not included among the excluded owners or resource roles associated with the task. The ability to delegate task execution is an example of dynamic resource allocation.

When executing a task, a user may access data associated with the task. For example, the data can be in the format of a business process data object that includes one or more fields of data associated with the task. Performing the task can involve accessing one or more data objects associated with the task. The input to a task may require a user to access certain data fields in a data object in order to complete the task. In addition, once the task is complete, the user may access certain data fields in order to store the output of the task. The business analyst can associate one or more data objects with a task in the BPMN model 200.

A business analyst may require the business process to fulfill one or more security requirements. A need-to-know security requirement can restrict access to data based on a need-to-know basis. The need-to-know security requirement provides the principal assigned to a task access to the data for executing the task. In the case of a critical task, there may be additional data associated with the task that the principal assigned to the task may not access. A dual control, or four-eyes, security requirement can divide the responsibility of the execution of a task between two users. Both users complete their assigned duties related to the execution of the task in order to complete the execution of the task. The division of responsibility for the execution of a task can be referred to as a separation of duty security requirement. The division of responsibility for the task execution can mitigate the risk of fraud, for example. A data confidentiality security requirement can restrict access to data to specific users based on the confidential nature of the data.

The BPMN model 200 shows the tasks 202a-g in sequential order. A split, or fork 204 occurs where the business process model splits the task flow. The business process model can require the execution of task 202c and task 202d in parallel or simultaneously. A join 206 occurs in the business process model when the execution of both task 202c and task 202d are complete in order to merge the task flow.

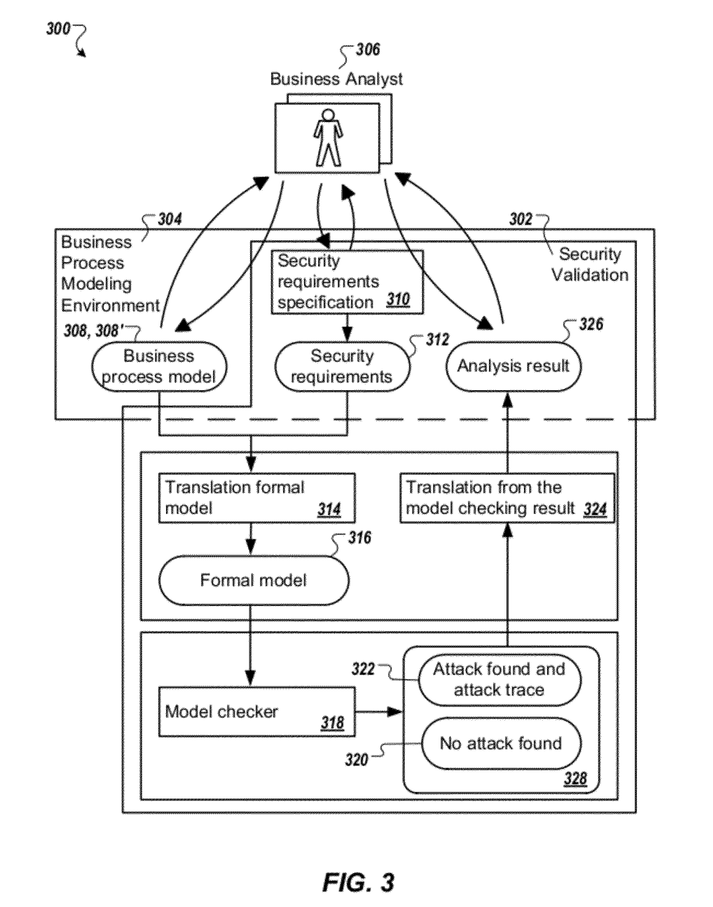

FIG. 3 is a flow diagram of a business process modeling (BPM) procedure in a process composer module 300 that includes a security validation procedure 302 in a business process modeling (BPM) environment 304. A business analyst 306 can use the BPM environment 304 to define a business process model 308. The business analyst can use BPMN in a graphical user interface to design the business process model 308, an example of which is shown in FIG. 2. A security requirements specification module 310 can provide a user interface to the business analyst 306. For example, referring to FIG. 1, a BPMS platform can run the BPM procedure on the computer system 106. The business analyst 306 can use client 102 to interface with the computer system 106 by way of network 110 in order to run the BPM procedure. The client 102 can display the user interface (e.g., a GUI) on the display device 102a. The user interface can allow the business analyst 306 to specify security requirements 312 (e.g., need-to-know, data confidentiality and/or dual control security requirements) that the business process model 308 should meet. The security validation procedure 302 determines whether the designed business process model 308 meets the specified security requirements.

The implementation of the user interface includes a set of identified security requirements for compliance. For example, the business analyst 306 can perform a security validation procedure 302 where the security requirements specification module 310 provides a wizard in the form of a user interface on the display device 102a. The business analyst, using the wizard, can specify need-to-know, dual control, and/or data confidentiality security requirements, among other possible security requirements for the business process. For example, in the case where the business analyst specifies a need-to-know security requirement, the wizard can provide a user interface that includes the task and the data fields associated with the task that the user executing the task can access.

For example, the business analyst 306 can start the security validation procedure 302 in the BPM environment 304 by activating a user control (e.g., a button) on the user interface, once the business process model 308 is defined and the security requirements 312 for the business process model are entered using the security requirements specification module 310. A formal model translation module 314 generates a formal model 316 from the business process model 308 and the specified security requirements 312. The formal model translation module 314 provides the formal model 316 that includes the security relevant aspects of the business process model 308. The formal model translation module 314 includes an algorithm that translates the business process model 308, written in BPMN, to the formal model 316, where the formal model 316 can be written in a meta-language. For example, a formal model is a mathematical description of a software and/or hardware system that includes a mathematical representation of the requirements of the system. The formal model translation module 314 can generate the formal model 316 that includes a mathematical representation of the BPM environment, a mathematical representation of the business process modeled by the business analyst in BPMN, and a mathematical representation of the security requirements entered by the business analyst through the user interface provided by the security requirements specification module 310.

A model checker module 318 analyzes the formal model 316 and checks all potential execution paths of the business process model using the specified security requirements. If an execution path of the business process model violates a security requirement, the model checker module 318 identifies the violation. The analysis of the model checker module 318 produces an output result 328. A “no violation found” result 320 occurs when the formal model 316 satisfies the specified security requirements. The analysis of the model checker module 318 can result in “a violation found and violation trace” result 322. The violation found and violation trace result 322 includes an identification of the security violation found by the model checker module 318 along with a trace of the related data flow and resource allocations in the business process model that resulted in the security violation.

A model checking result translation module 324 translates the output result 328 (the no violation found result 320 or the violation found and violation trace result 322) into an analysis result 326. Specifically, the model checking result translation module 324 translates the output result 328 into a graphical representation of the identified compliance issue that is in a format that a business analyst 306 can easily understand. The client 102 can display the analysis result 326 to the business analyst 306 in the user interface (e.g., a GUI) in the easily recognizable format. The business analyst 306, understanding the output result 328 of the model checker module 318, can determine the security requirement changes necessary to correct for the security violation. The business analyst 306 can implement proper counter-measures in the business process model 308 to resolve the cause of the security violation. The business analyst 306 can incorporate the changes into the business process model 308 to provide a modified business process model 308′ and rerun the security validation procedure 302 in order to determine whether the counter-measures implemented resolved the security violation, and whether other security violations are present.

In some implementations, the formal model translation module 314 can generate a formal model 316 using a specification meta-language (e.g., the AVANTSSAR Specification Language (ASLan)) that can allow for the execution of the tasks in a business process by the model checker module 318 in every possible way in order to identify security violations. The model checker module 318 can evaluate a transition system with respect to the security requirements 312 where the security requirements 312 define the security properties the business process model 308 must achieve. For example, a transition system is an abstract machine used for system computations. The machine can include a set of labeled states and transitions between states, where the labels are chosen from a set of labels. The formal model 316, specifically the representation of the BPM environment and the representation of the business process modeled by the business analyst in BPMN, defines a transition system. In this case, the transition system can represent the total number of sequences of tasks executed by the business resources, or software agents, that are allowed to perform the tasks. In addition, the formal model 316 can describe data and documents used within a task along with the resource requirements needed to access the data and documents. States of this transition system are sets of facts that satisfy a set of clauses (e.g., Horn clauses). The clauses provide a declarative mechanism to specify the dependencies among the facts. Rewrite rules enable the specification of transition rules. For example, an ASLan specification includes an initial state, clauses, rewrite rules, and security properties defined as violation states.

The attack states can be sets of facts that violate the desired properties of the transition system. For example, an attack state specification in ASLan can be syntactically similar to a rewrite rule. As a result, if the model checker module 318 identifies an attack state, the set of rules leading to the violation of the security requirements and provide the resultant violation trace. For example, the sequential tasks in a business process model can be expressed using rewrite rules that manage the facts ready(t) and done(t) in ASLan in a control flow. When the control flow indicates that a task is ready to be executed, the actual execution of the task can require a user who is willing and authorized to perform the task according to the access control security properties associated with the task. Clauses in ASLan can designate the set of potential owners and the set of excluded owners, as well as the users, that are authorized to execute the task. In dynamic resource allocation, a user can claim a task and then delegate the execution of the task to a delegated user where the delegated user is not included among the excluded owners or resource roles associated with the task. For example, ASLan can express the delegation of the task execution using a rewrite rule stating the delegated user receives the duty to execute the task from the user who claimed the task.

The data fields for business process data objects provide static information associated with a task. For example, ASLan can represent the data fields with facts that are included and held in the initial state during the business process execution. The association of inputs to a task and the association of outputs to a task are performed using the facts included in the initial state. In some implementations, execution of a task includes accessing data. In some situations, a user can delegate the execution of the task to a delegated user. As the execution of the task can involve data access, a delegated user may access data objects the delegated user does not have permission to access.

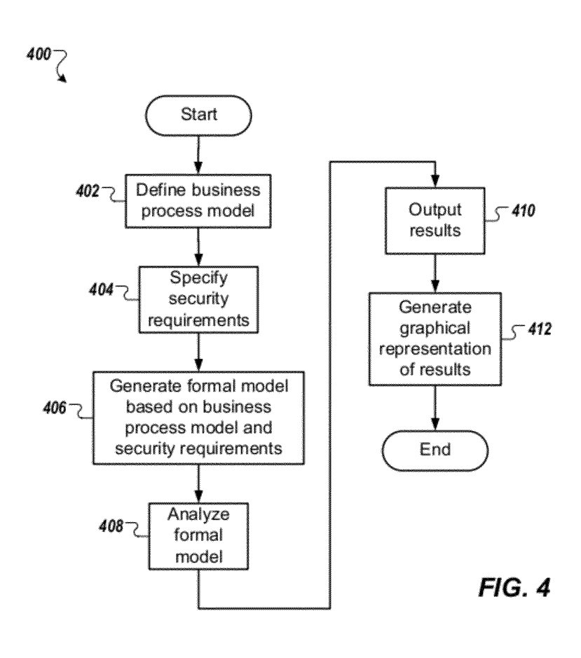

FIG. 4 is a flow chart of a business process modeling process 400 that includes security validation. For example, the modules described in the process composer module 300 in FIG. 3 can perform the process 400.

The process 400 starts with defining a business process model (402). For example, the business analyst 306 can define a business process model using BPMN (e.g., BPMN model 200 in FIG. 2). The BPMN model 200 can be input as the business process model 308. The security requirements for the business process model are specified (404). For example, the business analyst determines need-to-know, dual control, and/or data confidentiality among other possible security requirements for the business process. The security requirements specification module 310 can provide a user interface to the business analyst 306 to enable the business analyst to enter the security requirements for the business process model 308. A formal model is generated based on the business process model and the security requirements (406). For example, the formal model translation module 314 generates the formal model 316 from the business process model 308 and the specified security requirements 312. The formal model is analyzed (408). For example, the model checker module 318 analyzes the formal model 316. The results of the analysis of the formal model is output (410). For example, the model checker module 318 generates output result 328 that indicates whether a security violation was found, and, if so, the identity of the security violation and a violation trace leading to the security violation. A graphical representation of the results is generated (412). For example, the model checking result translation module 324 translates the output result 328 into analysis result 326, which is a graphical representation of the identified compliance issue that is in a format easily understood by the business analyst 306. The graphical representation of the identified compliance issue can be incorporated into the BPMN model 200 used to represent the business process allowing the business analyst 306 to identify where within the business process and under what conditions the security attack occurred. The process 400 ends.

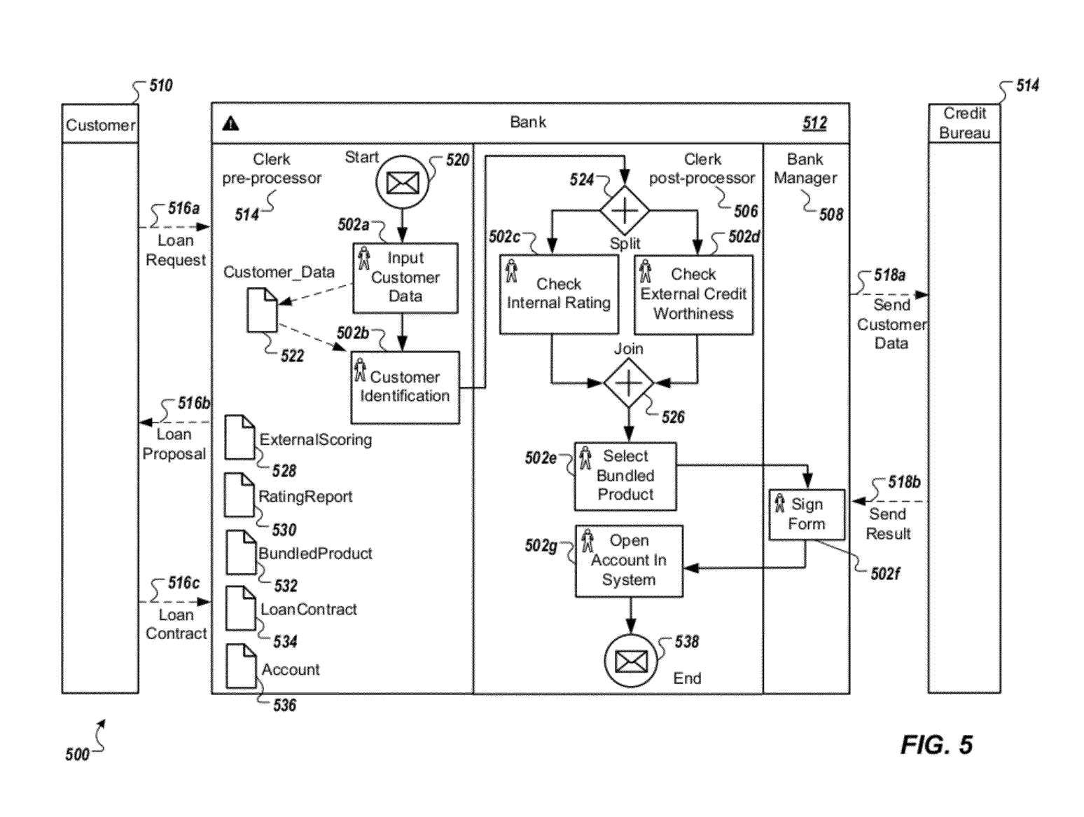

FIG. 5 is an example loan organization business process (LOBP) model 500 that can be generated using BPMN. For example, a business analyst can model a loan process for a bank to provide the LOBP model 500. Referring to FIG. 1, the business analyst can interact with a GUI on display device 102a of client 102 to design the LOBP model 500 using BPMN. The display device 102a can display the LOBP model 500.

The LOBP model 500 includes a sequence of tasks 502a-g that when executed by one or more business resources (e.g., users) can evaluate and possibly grant a bank customer a request for a loan amount. The business analyst assigns a bank resource role to each task. In the example of FIG. 5, a pre-processor clerk role 504 is assigned to tasks 502a-b, a post-processor clerk role 506 is assigned to tasks 502c-d, task 502e, and task 502g, and a bank manager role 508 is assigned to task 502f.

The tasks 502a-g can involve interaction with a customer pool 510, a bank pool 512, and a credit bureau pool 514. In the example of FIG. 5, the tasks 502a-g are included in the bank pool 512. The bank pool 512 can communicate with the customer pool 510 and the credit bureau pool 514 using a message exchange system in order to send and receive data and information related to the execution of the tasks 502a-g. Messages 516a-c can be communicated between the customer pool 510 and the bank pool 512 in order to exchange data and information between the bank and the customer. Messages 518a-b can be communicated between the credit bureau pool 514 and the bank pool 512 in order to exchange data and information between the bank and the credit bureau.

For example, a loan request message 512a represents the customer going to the bank to request a loan. The receipt of the loan request message 512a by the bank pool 512 triggers the start of the LOBP at the bank. The pre-processing clerks included in the pre-processing clerk role 504 receive and identify the customer's request at start 520. The pre-processing clerks launch the LOBP at the bank and update and/or create customer data 522 in the banking system by executing an input customer data task 502a. The pre-processing clerks execute a customer identification task 502b using the customer data 522 in order to identify the bank customer.

The post-processing clerk(s) included in the post-processor clerk role 506 analyze the credit worthiness of the identified customer. A split 524 in the LOBP occurs as the LOBP performs two or more tasks in parallel (tasks 502c and 502d). The post-processing clerk(s) execute an internal rating check task 502c to check the credit worthiness of the customer based on past bank transactions. In addition, the post-processing clerks execute an external credit worthiness check task 502d by communicating customer data to an external credit bureau, represented by a send customer data message 518a, in order to obtain credit worthiness data and information (e.g., a credit rating) for the customer.

The results of the external credit worthiness check task 502d are returned to the bank as represented by a send result message 518b from the credit bureau pool 514 to the bank pool 512. A join 526 occurs in the LOBP when the LOBP completes the execution of the parallel tasks 502c and 502d. The post-processing clerks execute a select bundle product task 502e to identify the most appropriate bundle product for the customer that includes the price of the loan. The bank submits to the customer a loan proposal along with the loan as represented by a loan proposal message 516b. In the case of the acceptance of the loan proposal, the customer signs the loan contract and returns it to the bank as represented by a loan contract message 516c. The returned and signed loan contract is provided to the bank manager. The bank manager executes a sign form task 502f in order to approve the loan. Once the bank manager approves the loan, the post-processing clerks execute an open account in system task 502g that opens a customer account for the loan in the banking system. The LOBP ends 538.

In addition, the pre-processing clerks manage a customer's external credit scoring data 528, a customer's rating report 530, a bundled product offered to a customer 532, a loan contract 534 and loan account data 536.

The LOBP model 500 can be associated with one or more security requirements. For example, the business analyst can specify one or more security requirements that are applicable to one or more of the tasks 502a-g of the LOBP model 500 as discussed above with reference to FIG. 3 (e.g., security requirements 312). The LOBP 500 and the security requirements are provided as input to a formal model translation module (e.g., the formal model translation module 314 of FIG. 3), which generates a formal model based thereon (e.g., the formal model 316 of FIG. 3). The formal model is provided as input to a model checker (e.g., the model checker 318 of FIG. 3), which processes the formal model to determine whether the business process violates any of the specified security requirements, as discussed above. The model checker outputs results that can include a simple indication that no violation was found, or that a violation was found. If a violation is found, a corresponding violation trace is also provided as part of the output result.

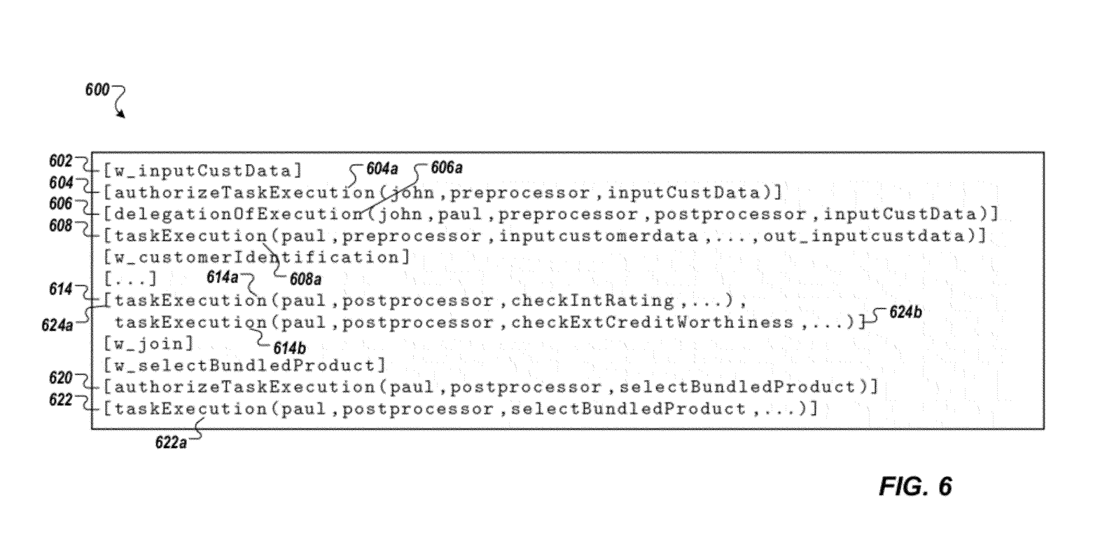

FIG. 6 illustrates an example model checker output raw violation trace 600 for the example LOBP model 500 of FIG. 5. In particular, the violation trace 600 is based on a violation of a need-to-know security requirement. Referring to FIG. 3, the violation trace 600 can be included in the output result 328 of the model checker module 318, specifically the violation found and violation trace result 322.

The violation trace 600 shows the output business process model trace leading to the security requirement violation. For example, referring to FIG. 5, the user selecting the loan offer (the post-process clerk selecting the bundled product for the customer) should not have access to specific customer data such as the customer's name or gender. The model checker module 318 outputs the violation found and violation trace result 322 indicating a violation of a need-to-know security requirement (e.g., the user can access customer data designated inaccessible by the security requirement). The violation found and violation trace result 322 includes the identification of the violation found and the raw violation trace 600.

For example, in the violation of the need-to-know security requirement for the LOBP model 500, the violation found can be expressed by the following statement: needToKnow_name(paul, out_all_inputcustomerdata). The violation found indicates that the user “Paul” violates the need-to-know security requirement. Referring to FIG. 5, the user Paul can access the data fields “name” and “gender” in a data object included in the customer data 522. The user Paul can access the data fields “name” and “gender,” because the user Paul can execute the input customer data task 502a and output the results of the task (e.g., the customer data 522). The user Paul can execute the input customer data task 502a because the pre-processing clerk “John” delegated the task to the post-processing clerk Paul and the input customer data task 502a is assigned to the pre-processor clerk role 504. The user Paul can execute the select bundled product task 502e in his role as a post-processing clerk as the select bundled product task 502e is assigned to the post-processing clerk role 506. In this situation, a security requirement violation occurs when the task of selecting the bundled product for the customer is assigned to user Paul (rule 622a of task 622) or when the input customer data task 502a is delegated to the user Paul.

The violation trace 600 indicates the flow that produced the security requirement violation. For example, the violation trace 600 includes a sequence of sets of instantiated ASLan rewrite rules that when executed result in the security requirement violation. The sequence of sets of instantiated ASLan rewrite rules are grouped according to their associated task. For example, rewrite rule instances represent rewrite rules 604a, 606a, 608a associated with task 602 (e.g., the input customer data task 502a in FIG. 5).

The square brackets (e.g., square brackets 624a-b) group rewrite rule instances that belong to the same execution step. Rewrite rules 604a, 606a, 608a belong to execution steps 604, 606, 608, respectively. Rules belonging to execution step i have to be executed before rules belonging to execution step j for any j>i (e.g., rule 604a in execution step 604 is executed before rule 606a in execution step 606). In addition, rules belonging to the same execution step may be executed in any order (e.g., rule 614a and rule 614b in execution step 614 can be executed in any order).

The model checking result translation module 324 can translate the raw attack trace 600 into a graphical format that can be presented to the business analyst in a GUI on a display device that can be more easily followed and understood by the business analyst. The graphical format is provided as analysis result 326 of FIG. 3.

In some implementations, the business analyst can set the post-processor clerk role 506 as an excluded owner for the input customer data task 502a in an updated business process model (e.g., BPM 308′ of FIG. 3) to prevent the security violation. However, this particular setting of the post-processor clerk role 506 does not fulfill the security requirements. A subsequent security validation check of the updated business process model identifies a security violation where the pre-processing clerk John executes the input customer data task 502a and is then delegated by Paul to execute the select bundled product task 502e.

Because the execution of tasks can be delegated to users in any role, the business analyst can define excluded individual owners for particular tasks. Defining excluded individual owners can prevent roles other than the roles identified as the potential owner of the task from delegating the execution of a task to users in other roles. The business analyst can run the security validation check and define excluded individual owners for particular tasks to correct for identified security requirements violations until no attack traces are detected by the security validation check. Alternatively, the business analyst can run the security validation check and define excluded owners for particular tasks until the business analyst acknowledges the risk posed by the remaining attack traces detected by the security validation check. For example, the business analyst can put in place monitoring systems to prevent fraud when the business process is executed.

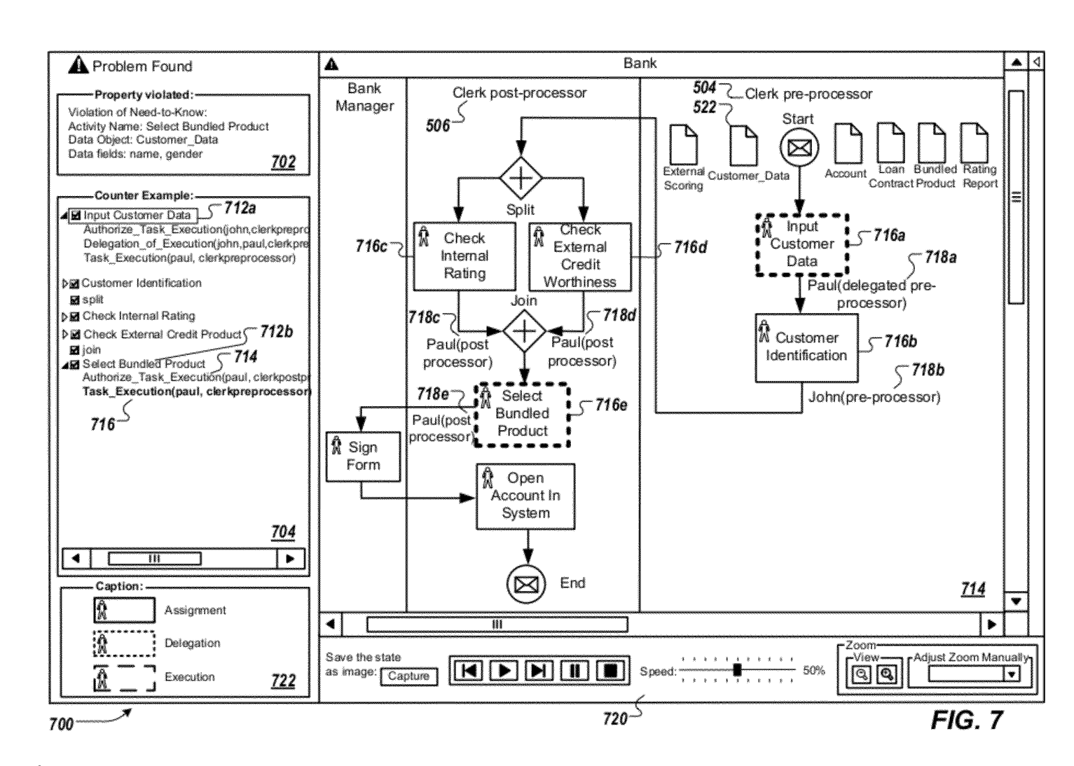

FIG. 7 illustrates a graphical view 700 of an analysis result (e.g., analysis result 326 of FIG. 3). For example, referring to FIGS. 1, 3, 5, 6 and 7, the graphical view 700 shows a violation of a need-to-know security requirement for the LOBP model 500. The model checking result translation module 324 translates the model checker output raw attack trace 600 included in the attack found and attack trace result 322 and, along with the identification of the attack found, produces analysis result 326 for display in the graphical view 700. The model checking result translation module 324 can incorporate the translation of the attack found and attack trace result 322 into the LOBP model 500 resulting in the graphical view 700. The display device 102a of client 102 can display the graphical view 700 to the business analyst. The business analyst can interact with a GUI on display device 102a of client 102 to review the graphical view 700 in order to determine where in the business process model the identified security violation occurred.

Property violation frame 702 shows the details of the identified security requirement violation. In some implementations, a business process model may violate one or more security requirements. The property violation frame 702 can show the details of each of the violated security requirements determined by the security validation procedure 302 in FIG. 3.

Counter example frame 704 shows the details of the business process tasks executed that result in the identified security requirement violation. The counter example frame 704 groups the executed ASLan rewrite rules that result in the security requirement violation with the associated business process task. In the counter example frame 704, execution steps 604, 606, 608 are shown as they relate to the input customer data task 502a as execution step entries 706, 708, 710, respectively, grouped together under an input customer data entry 712. Execution steps 620, 622 are shown as they relate to the select bundled product task 502e as execution step entries 714, 716, respectively, grouped together under an input customer data entry 712b. The counter example frame 704 highlights the one or more execution steps (e.g., execution step entry 716) that violated the security requirements.

Graphical counter example frame 714 shows a GUI representation of the business process model similar to the LOBP model 500. The graphical counter example frame 714 highlights the one or more tasks associated with the security requirement violation. For example, executed input customer data task 716a (corresponding to modeled input customer data task 502a) is highlighted as the user Paul was able to access the data fields “name” and “gender” in the customer data 522 (e.g., user Paul was included is included in the pre-processor pool 506). Executed select bundled product task 716e is highlighted as the same user, Paul, was assigned to the select bundled product task 502e. In order to execute the select bundled product task 502e, the user Paul may not access the data fields “name” and “gender” in the customer data 522, resulting in a need-to-know access violation. Therefore, the highlighted executed input customer data task 716a and the highlighted executed select bundled product task 716e indicate the executed tasks resulting in the security requirement violation. In addition, the graphical counter example frame 714 shows the user that claimed, delegated, or executed the task (e.g., users 718a-e associated with executed tasks 718a-e, respectively).

Commands and controls frame 720 includes buttons and controls a business analyst can use when interacting with the GUI of the graphical view 700. Caption frame 722 indicates the meaning of the colors used in the graphical view 700. For example, different colors can be used to represent if the user associated with a task claimed, delegated or executed the task.

In the case where the business process model does not violate any of the specified security requirements, the graphical view 700 can display a message to the business analyst informing the business analyst that no security violation was found.

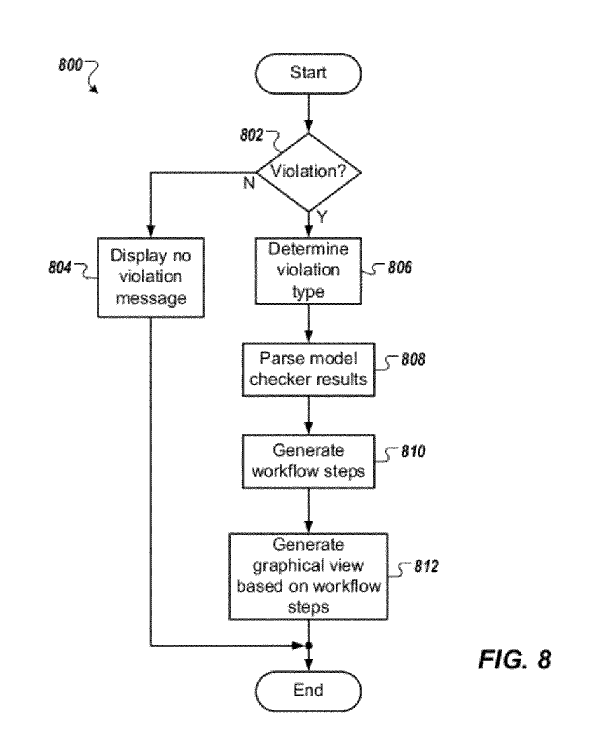

FIG. 8 is a flowchart of an example process 800 for translating a raw output trace (e.g., raw output trace 600 in FIG. 6) into an analysis result (e.g., analysis result 326 in FIG. 3). The process 800 is described with reference to FIGS. 1 and 3. The process 800 starts by determining whether a security violation occurred (802). For example, the model checking result translation module 324 parses the model checker output result 328 to determine if a security violation occurred. If it is determined that a security violation did not occur, a no violation message is displayed (804). For example, a GUI on the display device 102a of client 102 can display a no violation message to the business analyst.

If it is determined that a security violation did occur, the type of security violation is determined (806). For example, the model checking result translation module 324 analyzes the violation found and violation trace result 322 to determine the violation type (e.g., the model checking result translation module 324 parses the needToKnow_name(paul, out_all_inputcustomerdata) statement to determine the attack type). The violation type can include but is not limited to a violation of confidentiality: forbidden user or role violation type; a violation of confidentiality: forbidden organization violation type; a separation of duty violation type; a binding of duty violation type; and a need-to-know violation type. The process 800 parses the model checker results (808). For example, the model checking result translation module 324 parses the violation found and violation trace result 322 to extract relevant information from the violation trace result for the violation type. Parsing a raw violation trace (e.g., raw violation trace 600 in FIG. 6) provides violation steps performed by the execution of one or more tasks that the model checking result translation module 324 tokenizes into a list of strings (a violation step list). The process 800 generates workflow steps (810). For example, the model checking result translation module 324 uses the violation step list to create one or more workflow step objects. The workflow step objects can be displayed to the business analyst as part of the analysis result. The workflow step objects are created according to the detected security violation steps. A workflow step object can be created and inserted into a business process task. The process 800 generates the graphical view based on the workflow steps (812). For example, the model checking result translation module 324 creates workflow step objects for the analysis result 326, which are displayed in a GUI to the business analyst in a manner the business analyst can easily understand (e.g., the graphical view 700). The process 800 ends.

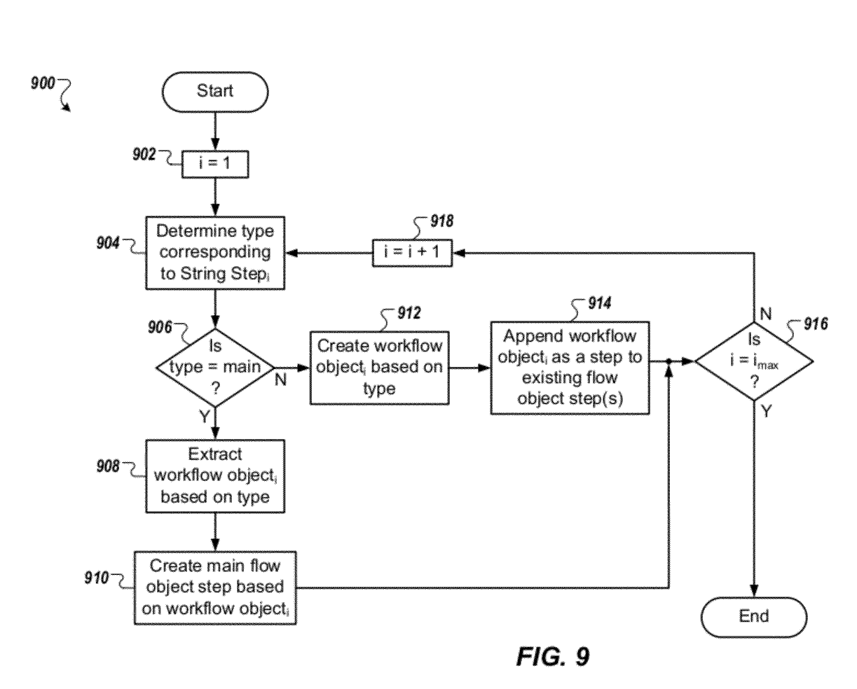

FIG. 9 is a flow diagram of an example process 900 for parsing an violation step list to create workflow steps for an analysis result. For example, the process 800 of FIG. 8 can produce the violation step list by parsing a raw violation trace (e.g., raw violation trace 600 in FIG. 6) for a determined violation type (e.g., a need-to-know security violation). The process 900 can extract entity names (e.g., the names for roles, users and tasks) and remap them to their business process model system counterparts. The process 900 uses task authorization to recursively look for substituted roles until the process 900 finds a role belonging to the assigned user. The process 900 is executed for each tokenized string in the attack step list.

The process 900 begins by setting an index i equal to one (902). The process 900 determines the step type corresponding to the string step with index i (904). The string step can be a step executed within a task that leads to a subsequent security violation. The string step type can include but is not limited to a grant delegation of permission type; a human task execution type; an automatic task execution with principal propagation type; an automatic task execution with no principal propagation type; an authorize task execution type; a substitution type; a main step type; and a delegation type.

In the case of a grant delegation of permission string step type or a human task execution string step type, the process 900 extracts entity names from the step. Referring to FIG. 3, a related BPMN message flow object for each entity name is determined using a mapping that was stored during the translation phase performed by the model checking result translation module 324 on the output result 328. The entity name and its related BPMN message flow object can be stored in a step subclass object. The process 900 can add the step subclass object to the corresponding parent step of the BPMN process model. In the case where the parent step does not exist, the process 900 can use the step subclass object to create the corresponding step.

In the case of an automatic task execution with principal propagation string step type, the process 900 determines an automated task. The determined automated task, a channel on which the task can send messages, and a receiving organization for the messages, are BPMN objects. The channel can be a message flow connector object that connects automated tasks with a service provider. In addition, the channel can be a message flow connector object on which the automated task sends the principal's propagation information (e.g., the principal's authorization token). The process 900 can create an object that receives the automated task, the message flow connector object and the destination organization along with a user and a role as parameters. In some implementations, the object can be included with the corresponding parent task step of the BPMN process model. In the case of an automatic task execution without principal propagation string step type, the process 900 determines the automated task and processes the string step type, as in the case of an automatic task execution with principal propagation string step type except there is no principal propagation. Without principal propagation, there is no information regarding users or roles.

In the case of a substitution string step type, if the process 900 finds a substitution, the process 900 stores the substitution in a list of substitutions for further use by the process 900.

In the case of an authorized task execution string step type, the process 900 extracts a user, role and task. If the user associated with the task does not have the role associated with the task, the process 900 searches the substitution list for a substitution that meets the criteria. The process 900 creates a step that associates the user, role, and substituted user with the task. In the case where the user associated with the task does have the role associated with the task, the process 900 need not search for or provide a substitution. In the case where the process 900 finds no substitution, then process 900 cannot provide a substitution. The process 900 adds the step to the parent task step.

In the case of a main string step type, the process 900 creates a BPMN task step using a corresponding BPMN message flow object.

In the case of a delegation string step type, the process 900 creates a delegation step that includes the extracted task owner and the user and the roles of the extracted task owner and the user along with the delegated activity. The delegation step is added to an existing parent task step.

If the step type is determined to be a main step type (906), the process 900 extracts the workflow object for the string step with index i (908). The process 900 creates a main flow object based on the workflow object for the string step with index i (910). In this case, a BPMN task for the main flow object is created for inclusion in the analysis result for display to the business analyst.

If in it is determined that the step type is not a main step type (906), a workflow object is created based on the string step with index i (912). The workflow object created based on the string step with index i is appended to a workflow object as a step to an existing workflow object step (914). In this case, the workflow object is appended to an associated BPMN task for inclusion in the analysis result for display to the business analyst. If the index i is equal to the maximum index value, iₘₐₓ, (916), then process 900 has processed all strings in the attack step list and the process 900 ends. If the index i is not equal to the maximum index value, iₘₐₓ, (916), then the index i is incremented by one (918) and the process 900 at 904.

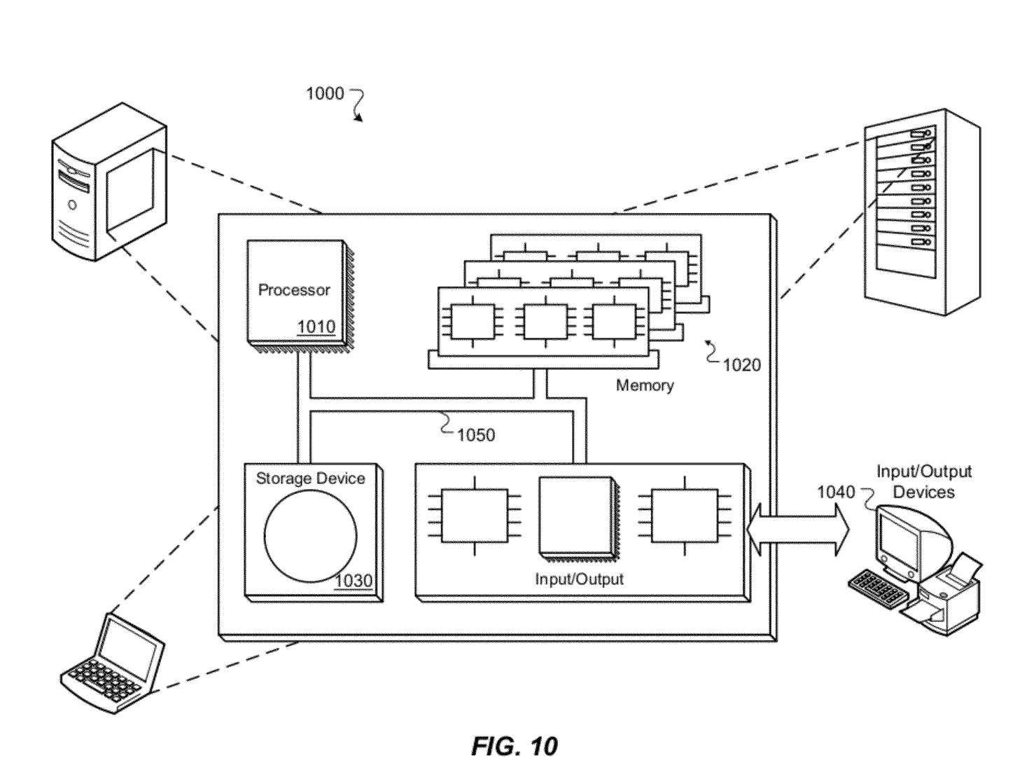

Referring now to FIG. 10, a schematic diagram of an example computing system 1000 is provided. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit. The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device. The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method of validating a process, the method comprising:
providing a process model based on the process, the process model comprising a plurality of tasks;
receiving user input at a computing device, the user input specifying one or more security requirements, the user input relating each of the one or more security requirements to at least one task of the plurality of tasks;
generating, using the computing device, a formal model of the process based on the process model and the one or more security requirements, the formal model being based on a specification meta-language;
processing the formal model using a model checker that is executed on the computing device to determine whether violation of at least one of the one or more security requirements occurs in the process;
generating an analysis result based on the processing; and
displaying the analysis result on a display.

2. The method of claim 1, further comprising:
detecting an occurrence of a violation of at least one of the one or more security requirements based on the processing; and
generating a violation found message and violation trace in response to detecting the occurrence of the violation, the analysis result being based on the violation found message and the violation trace.

3. The method of claim 1, further comprising:
generating an output of the model checker, the output comprising a violation trace; and
translating the violation trace to provide one or more graphical objects, the analysis result comprising the graphical objects.

4. The method of claim 3, wherein the violation trace comprises one or more string steps, each graphical object of the one or more graphical objects corresponding to a string step.

5. The method of claim 3, wherein each string step of the one or more string steps comprises an instantiated rewrite rule of the specification meta-language.

6. The method of claim 3, wherein translating the violation trace comprises:
determining a violation type;
parsing the violation trace; and
generating one or more workflow steps based on the violation type, each of the one or more graphical objects corresponding to a workflow step.

7. The method of claim 6, wherein generating one or more workflow steps comprises:
determining that a string step of the violation trace comprises a main string step type;
extracting a workflow object; and
creating a main work flow object step based on the workflow object.

8. The method of claim 6, wherein generating one or more workflow steps comprises:
determining that a string step of the violation trace comprises a predefined string step type;
extracting data from the string step based on the predefined string step type;
generate a workflow object step based on the data; and
append the workflow object step to a main workflow object step.

9. The method of claim 1, wherein the model checker evaluates a transition system in view of the one or more security requirements, the transition system comprising one or more states provided as a set of facts that satisfy a set of clauses, the one or more states comprising a violation state.

10. The method of claim 1, further comprising:
determining that a violation of at least one of the one or more security requirements did not occur based on the processing; and
generating a violation not found message, the analysis result being based on the violation not found message.

11. The method of claim 1, further comprising:
receiving additional user input at the computing device;
modifying the process model based on the additional user input to provide a modified process model;
generating, using the computing device, a modified formal model of the process based on the modified process model and the one or more security requirements, the modified formal model being based on the specification meta-language; and
processing the modified formal model using the model checker to determine whether violation of at least one of the one or more security requirements occurs in the process.

12. The method of claim 1, wherein the one or more security requirements comprise one or more of a need-to-know security requirement, a confidentiality security requirement, a separation of duty security requirement, and a binding of duty security requirement.

13. The method of claim 12, wherein the confidentiality security requirement comprises one of a forbidden user security requirement, a user role security requirement, and a forbidden organization security requirement.

14. A non-transitory computer-readable storage medium coupled to one or more processors and having instructions stored thereon which, when executed by the one or more processors, cause the one or more processors to perform operations comprising:
providing a process model based on the process, the process model comprising a plurality of tasks;
receiving user input, the user input specifying one or more security requirements, the user input relating each of the one or more security requirements to at least one task of the plurality of tasks;
generating a formal model of the process based on the process model and the one or more security requirements, the formal model being based on a specification meta-language;
processing the formal model using a model checker to determine whether violation of at least one of the one or more security requirements occurs in the process;
generating an analysis result based on the processing; and
transmitting the analysis result for display to a user.

15. A system, comprising:
a display;
a computing device in communication with the display; and
a computer-readable storage device coupled to the computing device and having instructions stored thereon which, when executed by the computing device, cause the computing device to perform operations comprising:
providing a process model based on the process, the process model comprising a plurality of tasks;
receiving user input, the user input specifying one or more security requirements, the user input relating each of the one or more security requirements to at least one task of the plurality of tasks;
generating a formal model of the process based on the process model and the one or more security requirements, the formal model being based on a specification meta-language;
processing the formal model using a model checker to determine whether violation of at least one of the one or more security requirements occurs in the process;
generating an analysis result based on the processing; and
providing the analysis result for display on the display.
